(19) United States
(12) Patent Application Publication
(10) Pub. No.: US 2026/0330147 A1
(43) Pub. Date: Oct. 22, 2026

(54) Customization of Interpersonal Communications using Large Language Model-Powered Agents

(71) Applicant: Grammarly, Inc., San Francisco, CA (US)

(72) Inventors: Dimitrios Alikaniotis, New York, NY (US); Vipul Raheja, San Francisco, CA (US)

(21) Appl. No.: 19/183,767

(22) Filed: Apr. 18, 2025

(51) Int. Cl. G06F 40/40; G06F 40/166; G06F 40/253

(52) U.S. Cl. CPC G06F 40/40; G06F 40/166; G06F 40/253

(57) ABSTRACT

A method of personalizing a communication may include inputting a prompt including a source text indicative of an intended written communication between a particular sender and recipient, and obtaining, based on the prompt, an interaction profile corresponding to the particular sender and recipient. The method may further include selecting a set of agents, from among a plurality of executable agents, based on the interaction profile. Each agent may be configured to generate a critique based on a different characteristic of a plurality of characteristics. The method may further include performing an iterative critique process in relation to the source text, where each agent of the selected set generates a critique based on a corresponding characteristic, to produce a personalized source text customized to an observed style of communication between the particular sender and recipient. The method further may cause the personalized source text to be output to the sender.

### FIELD

At least one embodiment of the present disclosure pertains to natural language processing, and more particularly, to a technique for customizing natural language person-to-person communications.

### BACKGROUND

Electronic interpersonal communications such as electronic mail (email), direct messaging and team communication platforms (e.g., Slack, Discord) are ubiquitous today. While use of these types of communications is often a necessity, people are often under time pressure and would like to spend as little time as possible writing electronic messages. This is especially the case in the workplace, but also in other environments. Yet when writing an electronic message in a hurry, a person may pay too little attention to the use of proper tone and style for the particular communication being written. The person may thereby face a difficult choice between taking more time to write the message with proper tone and style versus rushing through writing the message to save time but possibly using inappropriate tone and/or style.

### BRIEF DESCRIPTION OF THE DRAWINGS

One or more embodiments of the present disclosure are illustrated by way

of example and not limitation in the figures of the accompanying drawings, in which like references indicate similar elements.

FIG. 1 illustrates an example of an environment in which a message personalization system can be implemented.

FIG. 2A illustrates an example of at least a portion of the message personalizer.

FIG. 2B illustrates an example of a portion of the message personalizer, which builds context for use in generation of a first draft and agent selection.

FIG. 3 illustrates an example of two different interaction profiles.

FIG. 4 illustrates an example of an overall process that may be performed by the message personalization system.

FIG. 5 illustrates an example of a detailed process for obtaining an interaction profile corresponding to a particular sender in a particular receiver.

FIG. 6 illustrates an example of the details of the iterative agent critique process.

FIG. 7A illustrates an example of a prompt from a particular sender being used to select a subset of available agents.

FIG. 7B illustrates an example of the first round of the critique process that may result when each of the selected agents processes the source text in FIG. 7A.

FIG. 7C illustrates an example of a modified source text that may be output by the ML model after the first critique round.

FIG. 8 is a high-level illustration of a processing system that can implement the personalization system, the sender user device, or both.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

Introduced here are a message personalization technique and system to generate text or adapt text that a user has written to a style appropriate for communication between that person and a particular designated recipient of the communication. The technique automatically identifies what the appropriate style would be for any given interaction (communication) and decides which aspects of the text to target and modify. Briefly, as described further below, the personalization system in at least some embodiments first constructs a writing profile for specific interactions, such as Profile 1 for when Person A communicates with Person B, Profile 2 for when Person A communicates with Person C, etc. Each profile is a characterization of that particular type of interaction across multiple writing dimensions (characteristics). Profiles can be constructed by examining past interactions between the two relevant individuals (sender and recipient), or if no such communications are available, by looking at past communications involving at least the recipient, or if none of those communications are available either, then by looking at past communications involving individuals with characteristics similar to the sender and recipient, or at least similar to the recipient.

To accomplish this, the personalization system (hereinafter simply “the system”) maintains a number of executable agents, each of which is tuned for a particular function, such as checking for appropriate tone, checking for appropriate style, checking for correct grammar, etc. Based on the profile for the intended interaction, the system decides which agents are the most relevant and selects those agents to process the interaction. For example, in a profile where correct grammar is not important (e.g., in personal messages between friends), the “Grammar Agent” might not be selected even if the message contains some minor grammatical mistakes.

After the agents are selected for the particular interaction, they begin providing feedback on or critiquing the text in one or more iterations, i.e., “expressing opinions” as to what would need to change in the source text (or the source text as previously modified) to achieve an optimal rewrite according to each particular agent's focus. Agents have access to each other's output, taking that into account to resolve any conflicts. The agents then make the appropriate rewrites. This process then iterates one or more times, if necessary, until there is no more feedback, returning modified text optimally customized for the interaction.

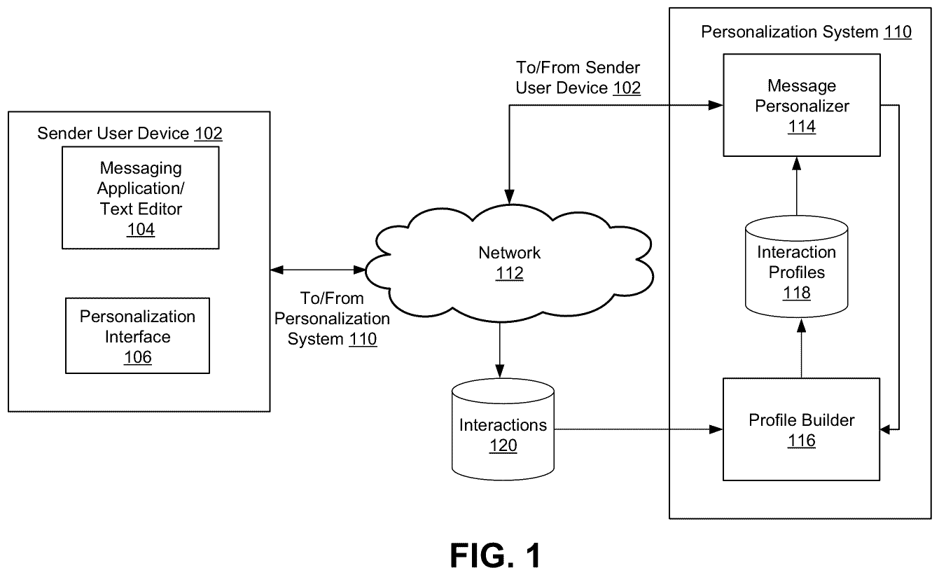

FIG. 1 shows an example of an environment in which the system can be implemented. A user is the author and/or the prospective sender of a message, hereinafter simply “sender.” In this context the terms “user” and “sender” are used interchangeably. The sender uses a sender user device 102, which includes a messaging application 104 that includes a text editing function, and which further includes appropriate input and output devices (not shown). In an example scenario, the sender wants to send a written message to another person (the “recipient”), such as via text, email, direct message, or a team collaboration platform. The sender uses the messaging application/text editor 104 to create a prompt to instruct the personalization system 110 how to construct a draft of the message. The prompt includes source text, which is either a preliminary draft of the message or a general instruction on how to create the message (e.g., “Write an email to user B about the quarterly report for Project X”). The user device also includes a personalization interface 106 that provides a bidirectional functional link to the personalization system.

The sender user device 102 may be, for example, a desktop computer, laptop computer, smartphone, tablet, or other similar device. The personalization interface 106 may be, for example, an application programming interface (API). The sender user device 102 may communicate with the personalization system 110 via a network 112. The network may be 112, for example, the Internet, a local area network (LAN), corporate intranet, wide area network (WAN), metropolitan area network (MAN), cellular telecommunications network, or any other type of network or combination of such networks.

The personalization system 110 may be implemented on one or more conventional processing devices, such as one or more server computers. Note that while they are shown as being separate in FIG. 1, in some embodiments the sender user device 102 and the personalization system 110 may be implemented in the same physical device, i.e., within the same housing.

The personalization system includes a message personalizer 114, a profile builder 116, and an interaction profiles database 118. The profile builder 116 builds interaction profiles, where each interaction profile relates to a particular pair of individuals. It does so based upon stored past interactions, which can be stored in one or more interactions databases 120. The interactions database(s) 120 can be, but are not necessarily, part of the personalization system 110. Interaction profiles constructed by the profile builder 116 are stored in the interaction profiles database 118.

The message personalizer 114 receives a prompt from the sender, and based on the prompt, it identifies and accesses an interaction profile appropriate for the intended interaction, and then personalizes a message to be sent based on that profile. The personalized message may be a modified version of the source text. The personalized message is than sent to the sender user device 102 (e.g., via the network 112), to be output to the sender by the sender user device 102. The sender may then cause the sender user device 102 to send the personalized message to the recipient as is, or the sender may further modify it as he sees fit.

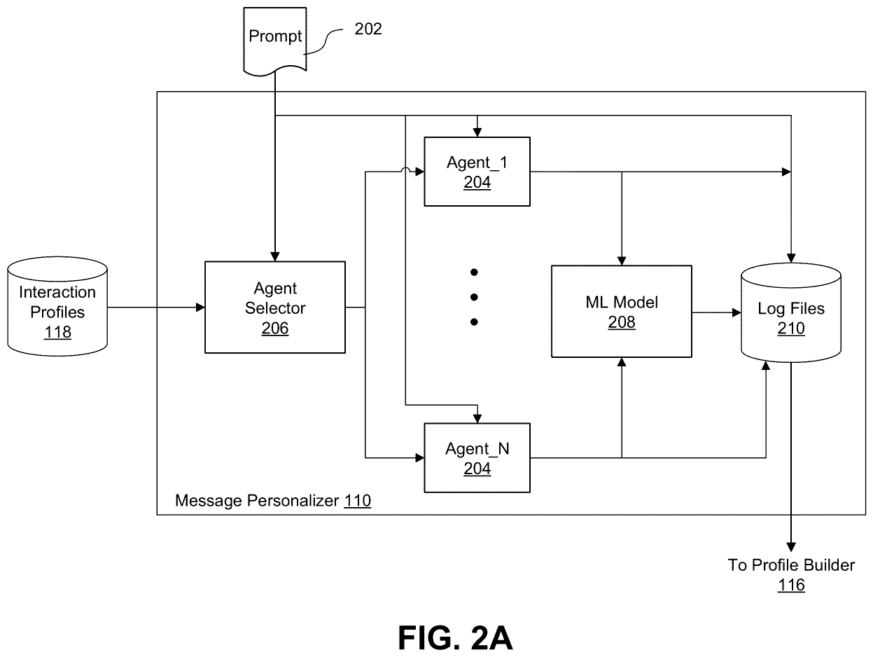

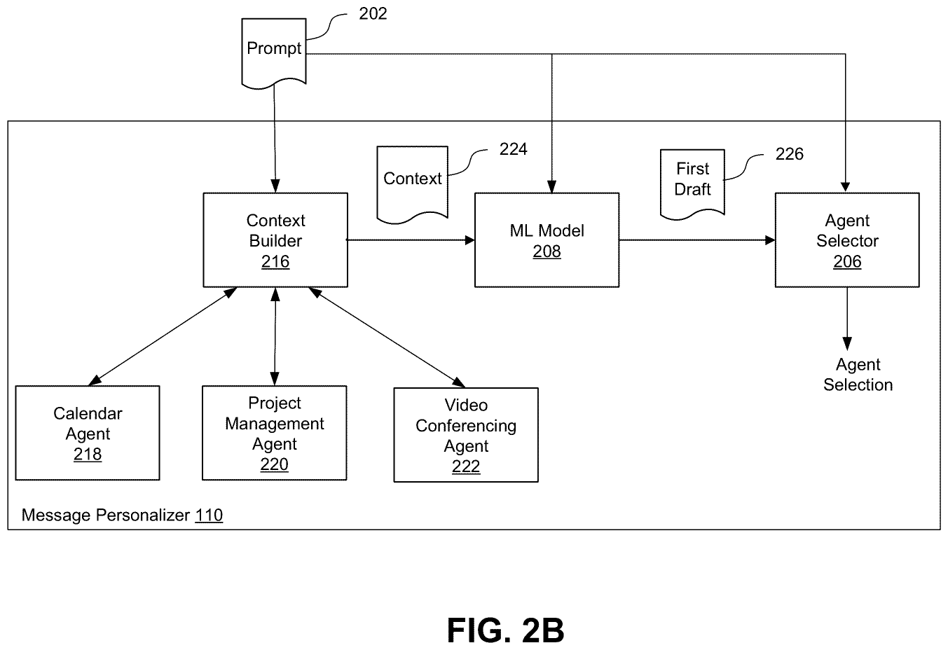

FIG. 2A illustrates an example of at least a portion of the message personalizer 114, in greater detail. As shown, the message personalizer 114 includes a number (N) of agents 204, i.e., Agent_1 through Agent_N, an agent selector 206, a machine-learning (ML) model 208, and a log files database 210. The agent selector 206 receives the prompt 202 including the source text from the sender user device 102. The agents 204 are not identical in design or configuration, and in fact, no two agents 204 are identical. Each of the agents 204 is designed and/or configured to critique source text according to a different particular communication characteristic, such as tone, style, grammar, use of particular words and phrases, etc. Based on the prompt, and more particularly based on the identity of the sender and the intended recipient, the agent selector 206 retrieves the appropriate interaction profile, and uses that interaction profile to select a subset of (generally at least two, but not all) of the agents to process the interaction. Each of the selected agents 204 then processes the source text according to its particular design/configuration and outputs a critique of that source text, indicating how well it aligns with the focus of that particular agent. For example, a tone agent may suggest changes to the source text to make the tone more friendly if the profile for the intended communication corresponds to two friends. In some embodiments, each agent 204 outputs its critique in the form of natural language text. In some embodiments, each agent 204 may also output a numerical score to indicate how close the source text is to being optimal according to that agent's particular focus. Each agent 204 then outputs its critique to the ML model 208, which produces a modified version of the source text based on the outputs from the selected agents 204. The original source text, outputs of the agents, and output of the ML model 208 are all stored in the log files database 210, and are used by the selected agents and the ML model 208 in any necessary subsequent iteration(s) of the critique/modification process.

In some instances it may be helpful to have additional context regarding an interaction to support generation of a first draft of the interaction and agent selection for the interaction. FIG. 2B illustrates an example of the relevant portion of the message personalizer 110 for an embodiment that builds context for use in generation of a first draft of the interaction and agent selection. The embodiment of FIG. 2B may be viewed as an extension of the embodiment in FIG. 2A. In the embodiment of FIG. 2B, the message personalizer 110 further includes a context builder 216, which decides which pieces of supporting context are desirable or necessary to be gathered for the interaction, if any. Supporting context is any additional information that is not present in the user prompt already, but that may be present in additional knowledge bases such as wikis, emails, Slack messages, etc., which could be contextually useful and could make the interaction more rich contextually (e.g., by adding relevant links/references, etc.). For example, if the user prompt was, “Write an email to user B about the quarterly report for Project X,” the additional context might be additional information relating to Project X.

Context building can be split into two stages: First, the context builder 216 figures out which sources of information can be queried to add more context for this task. Once that is determined, the context builder 216 spawns different knowledge- source-specific agents to gather the required knowledge. For example, as shown in FIG. 2B, the context builder 216 might spawn a first agent 218 to search a calendar application/database (e.g., Microsoft Outlook) for relevant calendar entries; a second agent 220 to search a project management/issues application/database (e.g., Jira) for relevant trouble tickets; and a third agent to search a video conferencing application/database (e.g., Zoom) for relevant meetings. Other possible sources of context might include, for example, relevant past emails, messages from a team collaboration platform such as Slack, documents from cloud storage (e.g., Google Drive), etc.

Once the respective knowledge-gathering agents are spawned and they query their respective knowledge sources for relevant content, the context builder 216 then aggregates the gathered context information into a context document 224, which it provides to the ML model 208. The ML model 208 then uses the context document 224 along with the user prompt 202 to generate a first draft 226 of the interaction, which it provides to the agent selector 206. The agent selector 206 uses the first draft 226 along with the user prompt 202 to make its selection of agents 204 for the interaction.

In some embodiments, the ML model 208 is a large language model (LLM), such as an instance of ChatGPT-4o or any other LLM with similar capability. Additionally, in some embodiments, each of the agents 204 may be implemented as an instance of an LLM with a particular customized prompt as its input), which that LLM can be but is not necessarily the same instance of, or the same type of LLM as, the ML model 208. In some embodiments, the ML model 208 may be incorporated into each of the agents 204, or the agents 204 may be incorporated into the ML model 208. In some embodiments, the agents 204 and the ML model 208 may all be implemented using a single instance of an LLM.

In an embodiment in which each of the agents 204 is implemented as an LLM with a customized prompt, the following list of example LLM prompts may be used to implement at least some of the agents 204 (note that this list does not represent all possible agents 204):
Sentence Length Agent: “You are Sentence Length Agent, a referee in this task. Your focus is on assessing the sentence length for readability and coherence. Ensure that each sentence is neither too long nor too short, maintaining a natural flow that enhances the reader's understanding. Provide insights into optimal sentence lengths for clarity and engagement.”
Vocabulary Usage Agent: “You are Vocabulary Usage Agent, a referee in this task. Your responsibility is to assess the vocabulary choices, ensuring they are appropriate for the target audience and topic. Check if the vocabulary aligns with the intended tone and accessibility, avoiding overly complex or simplistic words unless specifically suited to the context.”
Style Agent: “You are Style Agent, a referee in this task. You focus on the writing style, ensuring consistency and appropriateness for the intended purpose and audience. Examine elements like formality, literary devices, and adherence to a specific stylistic guideline, ensuring that the writing aligns with the expected stylistic standards.”
Tone Agent: “You are Tone Agent, a referee in this task. Your role is to evaluate the tone, ensuring it aligns with the intended emotional impact and audience expectations. Critically assess whether the tone is appropriate, whether it be formal, conversational, enthusiastic, or neutral, and suggest adjustments if necessary.”
Emoji Usage Agent: “You are Emoji Usage Agent, a referee in this task. Your job is to evaluate the use of emojis for appropriateness and effectiveness. Ensure that emojis are used in a way that enhances communication, does not overwhelm, and is suitable for the audience and platform, providing feedback on when to include or exclude them.”
Discourse Marker Usage Agent: “You are Discourse Marker Usage Agent, a referee in this task. Your focus is on evaluating discourse markers (e.g., ‘however,’ ‘therefore,’ ‘in addition’) to ensure smooth transitions and coherence. Check if they are used effectively to clarify relationships between ideas and guide the reader through the text.”
Paragraph Structure Agent: “You are Paragraph Structure Agent, a referee in this task. You focus on the organization and coherence of paragraphs, ensuring each paragraph contains a clear main idea and flows naturally to the next. Look for effective use of introductory, supporting, and concluding sentences in each paragraph.”
Punctuation Usage Agent: “You are Punctuation Usage Agent, a referee in this task. Your role is to assess the use of punctuation for clarity and correctness. Ensure punctuation enhances readability, clarifies meaning, and adheres to standard conventions, offering suggestions for any areas where it may disrupt flow or comprehension.”
Grammar Agent: “You are Grammar Agent, a referee in this task. You are responsible for identifying and correcting grammatical errors. Ensure that grammar is accurate and consistent throughout, providing clarity to the writing and preventing misunderstandings caused by incorrect grammar usage.”
Clarity Agent: “You are Clarity Agent, a referee in this task. Your focus is on ensuring the text is easy to understand and free of ambiguity. Evaluate sentence structure, word choice, and organization to ensure the message is conveyed directly and comprehensibly, suggesting ways to eliminate confusion if present.”
Headers Usage Agent: “You are Headers Usage Agent, a referee in this task. Your responsibility is to examine the use of headers to ensure that they guide the reader effectively through the text. Assess if headers are descriptive, relevant, and help to break down content logically for easy navigation.”
Bullet Points Agent: “You are Bullet Points Agent, a referee in this task. Your focus is on the effective use of bullet points to improve readability and clarity. Ensure bullet points are used when appropriate, helping to simplify complex information, and maintaining consistency in formatting and style.”
Jargon Usage Agent: “You are Jargon Usage Agent, a referee in this task. You are responsible for assessing the use of technical or specialized language. Ensure that jargon is appropriate for the audience and not overused, maintaining accessibility while also adding credibility when needed.”
Statistics Usage Agent: “You are Statistics Usage Agent, a referee in this task. You evaluate the use of statistical information, ensuring data is relevant, accurate, and effectively supports arguments or insights. Check that statistics are presented clearly and appropriately sourced, adding credibility without overwhelming the reader.”
Idioms Usage Agent: “You are Idioms Usage Agent, a referee in this task. Your job is to assess the use of idiomatic expressions for cultural appropriateness and clarity. Ensure idioms enhance the message without causing confusion, especially for audiences who may be unfamiliar with the expressions.”
Language Usage Agent: “You are Language Usage Agent, a referee in this task. Your focus is on evaluating the choice and appropriateness of languages used in communication. Ensure that the languages used are suitable for the audience and task, and check for correct code-switching if multiple languages appear.”
Preferred Phrases Agent: “You are Preferred Phrases Agent, a referee in this task. Your responsibility is to monitor the use of preferred phrases, ensuring their presence aligns with desired guidelines or company policies. Encourage the consistent use of these phrases for branding or tone purposes.”
Avoided Phrases Agent: “You are Avoided Phrases Agent, a referee in this task. Your role is to ensure that specific, undesired phrases are excluded. Check for any phrases that could be potentially confusing, inappropriate, or off-brand, advising alternative expressions when necessary.”

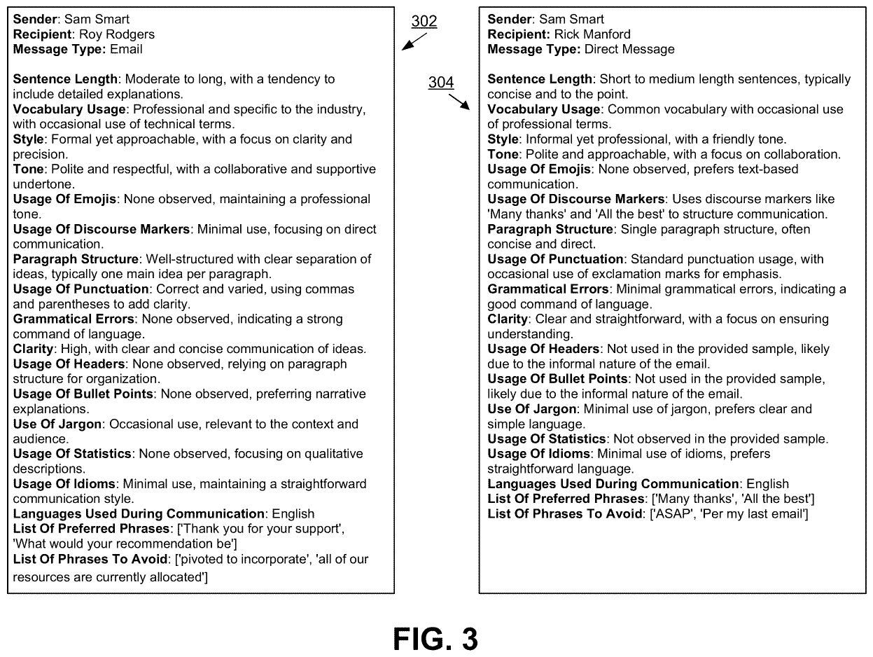

FIG. 3 shows an example of two different interaction profiles. Profile 302 is generated for, and is applicable to, any interaction between a particular sender, whose name in this example is Sam Smart, and a particular recipient, whose name in this example is Roy Rodgers. Profile 302 includes qualitative and/or quantitative values (text and/or numeric) for each of a number of characteristics, including sentence length, vocabulary usage, style, tone, usage of emoji's, usage of discourse markers, paragraph structure, usage of punctuation, grammatical errors, clarity, usage of headers, usage of bullet points, use of jargon usage of statistics, usage of idioms, language used during communication, preferred phrases, and phrases to avoid. Profile 304 is generated for, and is applicable to, any interaction between the particular sender, Sam Smart, and a different particular recipient, whose name in this example is Rick Manford. Profile 304 includes some but not all of the characteristics present in profile 302, to illustrate that different profiles may include data for different characteristics, since not all characteristics are relevant to every profile/interaction/pair of individuals.

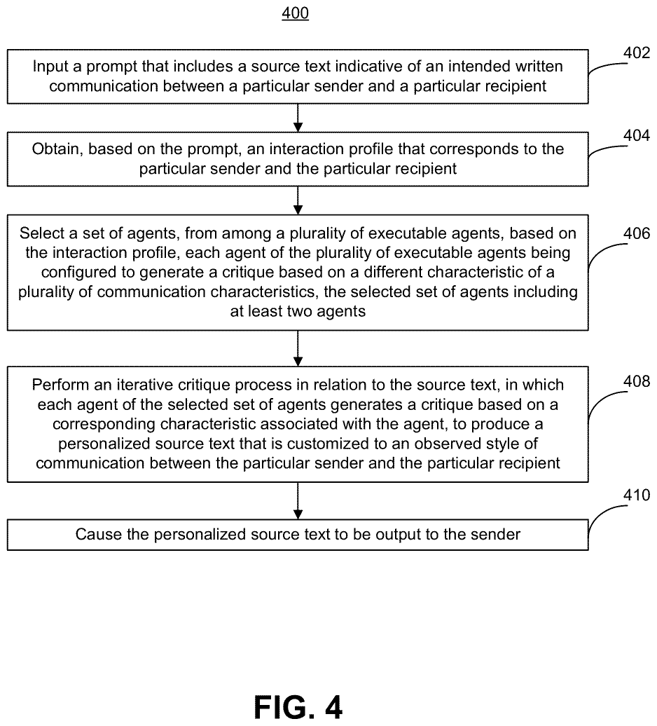

FIG. 4 illustrates an example of an overall process 400 that may be performed by the system (e.g., personalization system 110). The process begins at step 402, where the system inputs a user-generated or user-triggered prompt from a user device (e.g., sender user device 102). The prompt is based on user input from a particular sender (user) and includes source text indicative of an intended written communication between the particular sender and a particular recipient. Next, at step 404 the system obtains, based on the prompt, an interaction profile that corresponds to the particular sender and the particular recipient. The step of obtaining the interaction profile is described in greater detail below. At step 406, the system selects a set of agents, from among a plurality of executable agents (e.g., agents 204), based on the interaction profile. Each agent of the plurality of executable agents is configured to generate a critique of the source text based on a different characteristic of a plurality of communication characteristics (e.g., tone, style, grammar). The selected set of agents in this example process 400 includes at least two agents, although in some embodiments or instances, the selected set of agents may include only a single agent. Finally, at step 408, the system performs an iterative critique process in relation to the source text. In this iterative process, each agent of the selected set of agents generates a critique based on its corresponding focus characteristic (e.g., tone, style, grammar). In this step, each agent of the selected set of agents produces a modified source text that is customized, based on the interaction profile, to the observed style of communication between the particular sender and the particular recipient. After completion of all iterations, the system causes the resulting modified (personalized) source text to be output to the sender at step 410.

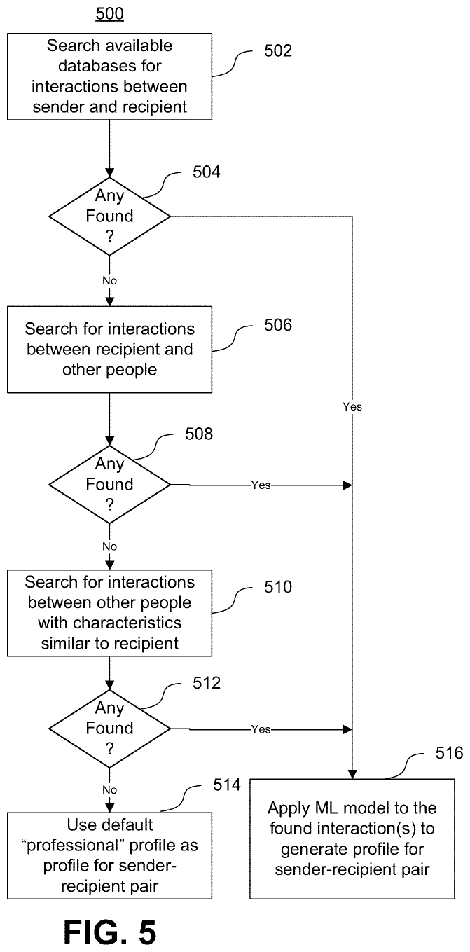

FIG. 5 illustrates a process 500 representing an example of step 404, obtaining the interaction profile, in greater detail. Process 500 starts with step 502, in which the profile builder searches any available database(s) for interactions (communications) between the particular sender and the particular recipient specified in the input prompt. These interactions may be, for example, past texts, emails, direct messages and/or messages sent through a team collaboration platform such as Slack, or the like, or any combination of such messages. If one or more such interactions are found (step 504), the process proceeds to step 516, which includes applying a ML model (e.g., ML model 208) to the found interaction(s) to generate a profile for the particular sender and recipient (“sender-recipient pair”). This may be done by, for example, taking a few high-fidelity texts that belong to a given user to balance quality and diversity, and using an LLM to output the profile of a user based on the input texts.

If no such interactions are found in step 504, then the process instead proceeds from step 504 to step 506, which includes searching available databases for any interactions between the particular recipient specified in the input prompt and any other person(s). If any such interactions are found (step 508), the process proceeds to step 516, which includes applying a ML model (e.g., ML model 208) to those interactions to generate a profile for the sender-recipient pair. Otherwise, the process instead proceeds from step 508 to step 510, which includes searching available databases for interactions between any other people who have characteristics similar to the recipient. Any convenient technique may be used to determine whether two particular individuals have “similar” characteristics for purposes of step 510; the specific method and criteria for determining whether two individuals are similar or sufficiently similar are not germane to this disclosure. If any such interactions are found, the process proceeds to step 516, which includes applying a ML model (e.g., ML model 208) to those interactions to generate a profile for the sender-recipient pair. Otherwise, the process proceeds to step 514, by using a default “professional” profile as the profile for the sender-recipient pair.

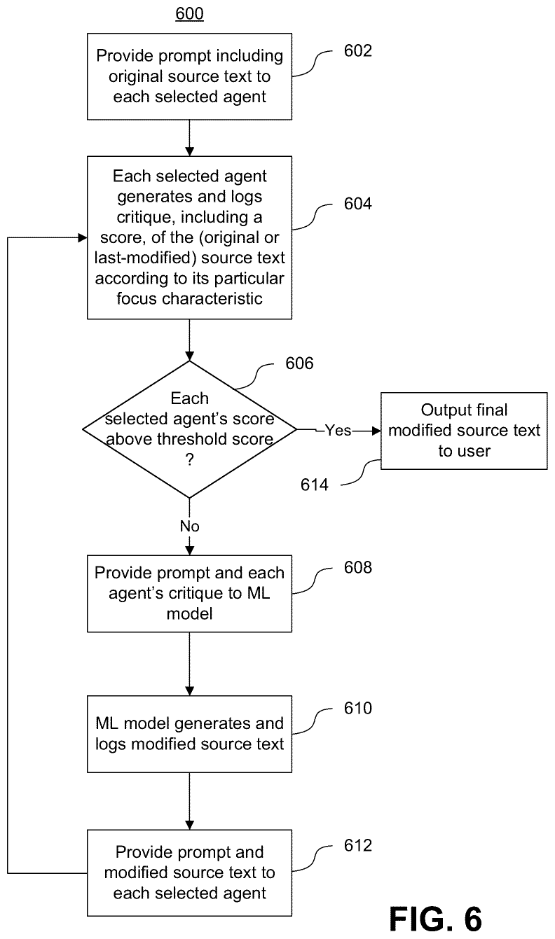

FIG. 6 illustrates a process 600 representing an example of step 408, the iterative agent critique process, in greater detail. Process 600 begins with step 602, in which the system provides the prompt generated by the user (including the original source text) to each selected agent (i.e., each agent selected by the agent selector based on the input prompt). The source text may include an initial draft of the message, or it may include just a high-level instruction on what the message should say. Next, at step 604, each selected agent generates and logs its critique of the source text (i.e., the original source text or the last-modified source text per step 610 below). For each selected agent, the critique output by that agent may include both a natural language evaluation of the source text and a numerical score indicative of how well the source text aligns with the particular focus of that agent. At step 606, each selected agent's output score is compared to a threshold value. If the output scores of all of the selected agents are above the threshold value, then the process proceeds to step 614, in which the final modified source text is output (or caused to be output) to the user (sender). This step may include the personalization system sending the modified source text to the sender's user device via a network, to cause the modified source text to be output to the sender.

If not all of the selected agents' scores exceed the threshold value in step 606, then the process instead proceeds from step 606 to step 608, which includes providing the prompt and each agent's critique to the ML model (e.g., ML model 208). The ML model then generates and logs a modified source text at step 610, based on the critiques generated by the selected agents. At step 612, the process provides the prompt and the modified source text from step 610 to each selected agent, and the process then loops back to step 604. It can be seen, therefore, that in the illustrated embodiment, this iterative process repeats until the scores output by each of the selected agents all exceed a threshold value.

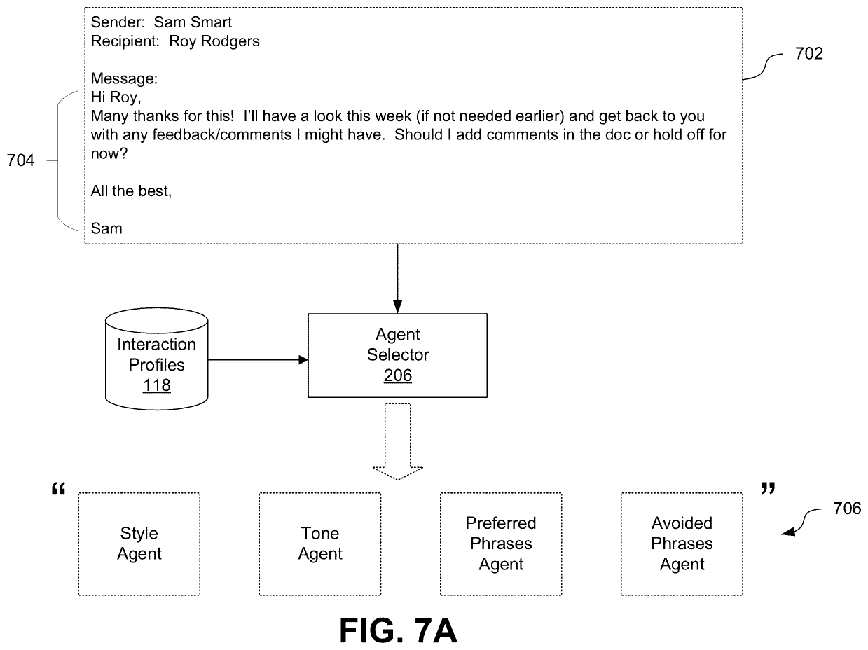

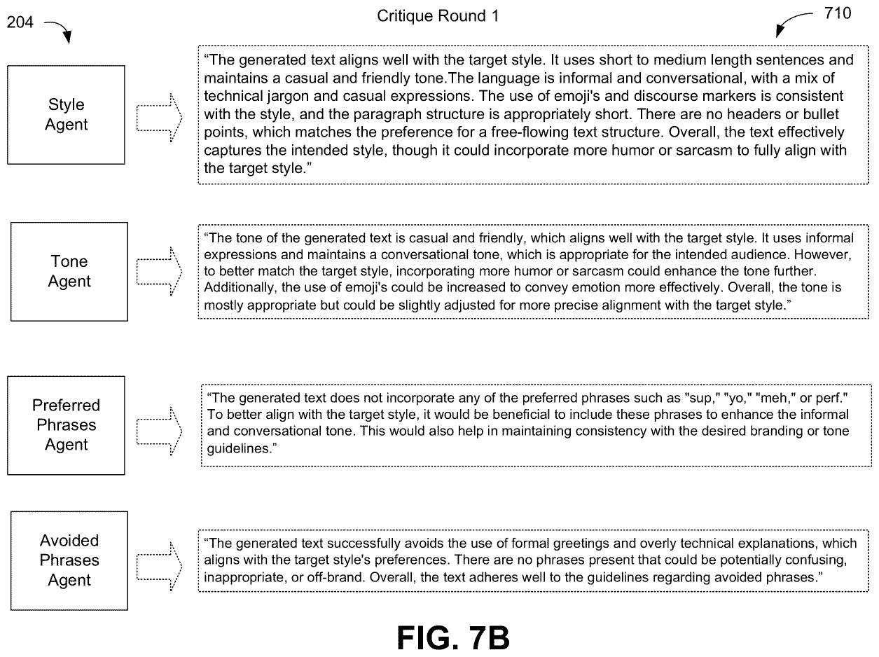

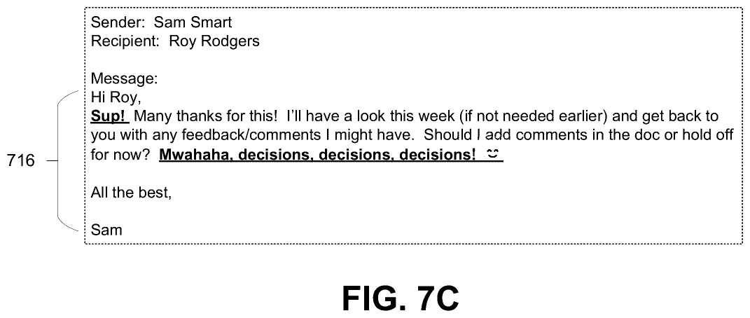

FIGS. 7A through 7C illustrate an example of how a particular prompt can be processed by the system to produce an output message that is customized for a particular interaction (i.e., sender and recipient). In particular, FIG. 7A illustrates an example prompt 702, which in this case includes a user-created draft of a message to be sent by a sender, Sam Smart, to a recipient, Roy Rodgers. The source text 704 is the message (i.e., “Hi Roy, Many thanks for this! . . . ”). The prompt 702 is input to the agent selector 206. The agent selector 206 looks at the identities of the particular sender and recipient, identifies the appropriate interaction profile from the interaction profiles database 118 based on the sender and recipient, and based on that profile, selects the appropriate agents 204 for the interaction. As a result, in this particular example, the agent selector 206 produces an output 706 that selects (or that specifies selection of) a style agent, a tone agent, a preferred phrases agent, and an avoided phrases agent. In other examples, a different set of agents may be selected for a particular source text.

FIG. 7B illustrates an example of the first round of the critique process that may result when each of the selected agents in FIG. 7A processes the source text 704. In particular, FIG. 7B shows an example of the outputs 710 that the selected agents 204 may produce. These outputs are then provided to the ML model 208, to cause the ML model 208 to produce a modified source text. FIG. 7C illustrates an example of a modified source text 716 that may be output by the ML model 208 after the first critique round (added text is shown in bold, underlined font). The modified source text 716 is then provided as input back to each of the selected agents 204, along with a history of all prior versions of the source text (e.g., from the log files database 210).

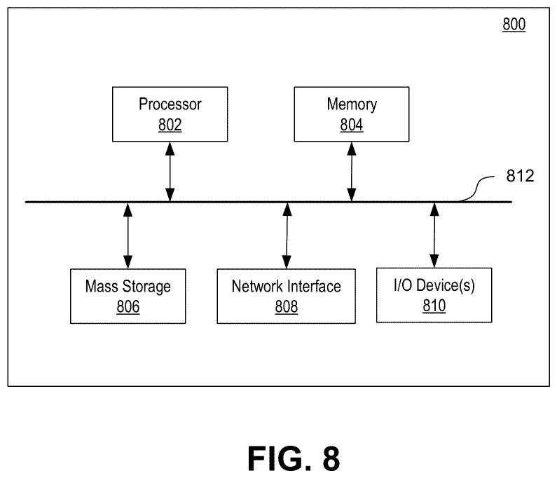

In various embodiments, the personalization system 110 made be implemented entirely or partially in the form of one or more programmable general- purpose processors programmed with appropriate instructions. Further, the personalization system 110 can be implemented at least partially in the form of special- purpose, hardwired circuitry. As noted above, the personalization system can be implemented in any conventional processing device, which may be, for example, one or more server computers, personal computers, etc. FIG. 8 is a high-level illustration of a processing system 800 that can implement the personalization system 110, the sender user device 102, or both. In some embodiments, multiple instances of a computer system 800 communicating with each other may be used to implement the personalization system 110, the sender user device 102, or both.

As shown, computer system 800 includes one or more processors 802, one or more memories 804, one or more mass storage devices 806, one or more network interfaces 808, and one or more input/output (I/O) devices 810, all coupled to each other by an interconnect system 812. The processor(s) 802 each may be or include a general-purpose programmable microprocessor, Graphics Processing Unit (GPU) or General Purpose GPU (GPGPU), Digital Signal Processor (DSP), Application-Specific Integrated Circuit (ASIC), Programmable Logic Device (PLD), Field Programmable Gate Array (FPGA), programmable microcontroller, System-on-a-Chip (SoC), or other similar device(s), or a combination of such devices. The memory 804 may be or include, for example, one or more instances of random-access memory (RAM), read-only memory (ROM), flash memory, or the like, or a combination of such devices. The mass storage device(s) 806 each may be or include, for example, internal flash memory, hard disk, USB flash drive, or other similar device, or a combination of such devices. Network interface(s) 808 each may be or include, for example, a Wi-Fi adapter, Ethernet adapter, Bluetooth chip, or other similar device, or a combination of such devices. The I/O devices 810 may include any one or more of, for example: a keyboard, mouse, touchpad, microphone, camera, display device, audio speaker, etc. The interconnect system 812 may be or include one or more direct (point-to-point) connections, system buses and/or peripheral buses, which may include any one or more of, for example, a Peripheral Component Interconnect (PCI), PCI Express (PCle), Universal Serial Bus (USB), Serial Advanced Technology Attachment (SATA), High-Definition Multimedia Interface (HDMI), DVI, RapidIO, Firewire (IEEE 1394), or other similar types of interconnect, or a combination of such interconnects.

### EXAMPLES OF CERTAIN EMBODIMENTS

The above disclosure can be summarized as set forth in the following numbered examples:
1: A machine-implemented method of personalizing a person-to-person communication, where the method may include: inputting a prompt that includes a source text indicative of an intended written communication between a particular sender and a particular recipient; obtaining, based on the prompt, an interaction profile that corresponds to the particular sender and the particular recipient; selecting a set of agents, from among a plurality of executable agents, based on the interaction profile, each agent of the plurality of executable agents being configured to generate a critique based on a different characteristic of a plurality of communication characteristics, the selected set of agents including at least two agents; performing an iterative critique process in relation to the source text, in which each agent of the selected set of agents generates a critique based on a corresponding characteristic associated with the agent, to produce a personalized source text that is customized to an observed style of communication between the particular sender and the particular recipient; and causing the personalized source text to be output to the sender.
2: The method as example 1 describes, where the iterative critique process includes a plurality of iterations, each of which may include: using each agent of the selected set of agents to modify the source text or a modified source text according to the corresponding characteristic for which the agent is configured, to output a separate agent-modified output text for each agent; and processing all of the agent-modified output texts from the selected set of agents concurrently to produce the modified source text; where the personalized source text is the modified source text after a final iteration of the critique process.
3: The method as either of examples 1 or 2 describe, where the critique process may include each agent generating a score for its agent-modified output text and one or more reasons for the score.
4: The method as any of examples 1-3 describe, where the critique process maintains state across iterations, such that each agent of the selected set of agents has access to the source text and to each agent-modified source text from each prior iteration of the critique process.
5: The method as any of examples 1-4 describe, where the critique process may include: each agent generating an agent-specific customized prompt for a large language model; and applying the agent-specific customized prompt from each agent to the large language model to produce an agent-modified output text for each agent.
6: The method as any of examples 1-5 describe, where each agent may include a separate instance of a large language model, trained for a particular characteristic corresponding to that agent.
7: The method as any of examples 1-6 describe, where the interaction profile may include an assigned value for each of the plurality of communication characteristics.
8: The method as any of examples 1-7 describe, further may include: generating the interaction profile automatically by analyzing prior communications between the particular sender and the particular recipient according to the plurality of communication characteristics.
9: The method as any of examples 1-8 describe, further may include: generating the interaction profile automatically by analyzing prior communications between people who have been determined to have similar characteristics to the particular sender and the particular recipient.
10: The method as any of examples 1-9 describe, further may include: generating the interaction profile automatically by: determining whether prior communications between the particular sender and the particular recipient are accessible; and in response to a determination that no prior communications between the particular sender and the particular recipient are accessible, generating the interaction profile by analyzing prior communications between people who have been determined to have similar characteristics to the particular sender and the particular recipient.
11: The method as any of examples 1-10 describe, where the prompt specifies the particular sender, the particular recipient, and the source text or a summary of the source text, and where the obtaining the interaction profile is based on the particular sender and the particular recipient.
12. A non-transitory machine-readable medium storing a set of instructions for personalizing a person-to-person communication, the set of instructions comprising instructions, execution of which by one or more processors in a device cause the device to perform a method as any of examples 1-11 describe.
13. A processing system comprising a communication device through which the processing system can communicate data with another processing system via a network; at least one memory coupled to the communication device; and one or more processors coupled to the at least one memory and configured to perform a method as any of examples 1-11 describe.

Unless contrary to physical possibility, it is envisioned that (i) the methods/steps described herein may be performed in any sequence and/or in any combination, and that (ii) the components of respective embodiments may be combined in any manner with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is Claimed is:

1. A machine-implemented method of personalizing a person-to-person communication, the method comprising:
inputting a prompt that includes a source text indicative of an intended written communication between a particular sender and a particular recipient;
obtaining, based on the prompt, an interaction profile that corresponds to the particular sender and the particular recipient;
selecting a set of agents, from among a plurality of executable agents, based on the interaction profile, each agent of the plurality of executable agents being configured to generate a critique based on a different characteristic of a plurality of communication characteristics, the selected set of agents including at least two agents;
performing an iterative critique process in relation to the source text, in which each agent of the selected set of agents generates a critique based on a corresponding characteristic associated with the agent, to produce a personalized source text that is customized to an observed style of communication between the particular sender and the particular recipient; and
causing the personalized source text to be output to the sender.

2. The method of claim 1, wherein the iterative critique process includes a plurality of iterations, each of which comprises:
using each agent of the selected set of agents to modify the source text or a modified source text according to the corresponding characteristic for which the agent is configured, to output a separate agent-modified output text for each agent; and
processing all of the agent-modified output texts from the selected set of agents concurrently to produce the modified source text;
wherein the personalized source text is the modified source text after a final iteration of the critique process.

3. The method of claim 1, wherein the critique process comprises each agent generating a score for its agent-modified output text and one or more reasons for the score.

4. The method of claim 1, wherein the critique process maintains state across iterations, such that each agent of the selected set of agents has access to the source text and to each agent-modified source text from each prior iteration of the critique process.

5. The method of claim 1, wherein the critique process comprises:
each agent generating an agent-specific customized prompt for a large language model; and
applying the agent-specific customized prompt from each agent to the large language model to produce an agent-modified output text for each agent.

6. The method of claim 1, wherein each agent comprises a separate instance of a large language model, trained for a particular characteristic corresponding to that agent.

7. The method of claim 1, wherein the interaction profile comprises an assigned value for each of the plurality of communication characteristics.

8. The method of claim 1, further comprising:
generating the interaction profile automatically by analyzing prior communications between the particular sender and the particular recipient according to the plurality of communication characteristics.

9. The method of claim 1, further comprising:
generating the interaction profile automatically by analyzing prior communications between people who have been determined to have similar characteristics to the particular sender and the particular recipient.

10. The method of claim 1, further comprising:
generating the interaction profile automatically by:
determining whether prior communications between the particular sender and the particular recipient are accessible; and
in response to a determination that no prior communications between the particular sender and the particular recipient are accessible, generating the interaction profile by analyzing prior communications between people who have been determined to have similar characteristics to the particular sender and the particular recipient.

11. The method of claim 1, wherein the prompt specifies the particular sender, the particular recipient, and the source text or a summary of the source text, and wherein the obtaining the interaction profile is based on the particular sender and the particular recipient.

12. A non-transitory machine-readable medium storing a set of instructions for personalizing a person-to-person communication, the set of instructions comprising instructions, execution of which by one or more processors in a device cause the device to:
input a prompt that includes a source text indicative of an intended written communication between a particular sender and a particular recipient;
obtain, based on the prompt, an interaction profile that corresponds to the particular sender and the particular recipient;
select a set of agents, from among a plurality of executable agents, based on the interaction profile, each agent of the plurality of executable agents being configured to generate a critique based on a different characteristic of a plurality of communication characteristics, the selected set of agents including at least two agents;
perform an iterative critique process in relation to the source text, in which each agent of the selected set of agents generates a critique based on a corresponding characteristic associated with the agent, to produce a personalized source text that is customized to an observed style of communication between the particular sender and the particular recipient; and
cause the personalized source text to be output to the sender.

13. The non-transitory machine-readable medium of claim 12, wherein the iterative critique process includes a plurality of iterations, each of which comprises:
using each agent of the selected set of agents to modify the source text or a modified source text according to the corresponding characteristic for which the agent is configured, to output a separate agent-modified output text for each agent; and
processing all of the agent-modified output texts from the selected set of agents concurrently to produce the modified source text; and
wherein the personalized source text is the modified source text after a final iteration of the critique process.

14. The non-transitory machine-readable medium of claim 12, wherein the one or more instructions further cause the device to:
generate the interaction profile automatically by analyzing prior communications between the particular sender and the particular recipient according to the plurality of communication characteristics.

15. The non-transitory machine-readable medium of claim 12, wherein the one or more instructions further cause the device to:
generate the interaction profile automatically by analyzing prior communications between people who have been determined to have similar characteristics to the particular sender and the particular recipient.

16. The non-transitory machine-readable medium of claim 12, wherein the prompt specifies the particular sender, the particular recipient, and the source text or a summary of the source text, and the obtaining the interaction profile is based on the particular sender and the particular recipient.

17. A processing system comprising:
a communication device through which the processing system can communicate data with another processing system via a network;
at least one memory coupled to the communication device; and
one or more processors coupled to the at least one memory and configured to:
input a prompt that includes a source text indicative of an intended written communication between a particular sender and a particular recipient;
obtain, based on the prompt, an interaction profile that corresponds to the particular sender and the particular recipient;
select a set of agents, from among a plurality of executable agents, based on the interaction profile, each agent of the plurality of executable agents being configured to generate a critique based on a different characteristic of a plurality of communication characteristics, the selected set of agents including at least two agents;
perform an iterative critique process in relation to the source text, in which each agent of the selected set of agents generates a critique based on a corresponding characteristic associated with the agent, to produce a personalized source text that is customized to an observed style of communication between the particular sender and the particular recipient; and
cause the personalized source text to be output to the sender.

18. The processing system of claim 17, wherein the iterative critique process includes a plurality of iterations, each of which comprises:
using each agent of the selected set of agents to modify the source text or a modified source text according to the corresponding characteristic for which the agent is configured, to output a separate agent-modified output text for each agent; and
processing all of the agent-modified output texts from the selected set of agents concurrently to produce the modified source text; and
wherein the personalized source text is the modified source text after a final iteration of the critique process.

19. The processing system of claim 17, wherein the one or more processors are further configured to:
generate the interaction profile automatically by analyzing prior communications between the particular sender and the particular recipient according to the plurality of communication characteristics.

20. The processing system of claim 17, wherein the prompt specifies the particular sender, the particular recipient, and the source text or a summary of the source text, and the obtaining the interaction profile is based on the particular sender and the particular recipient.
